(19) United States
(12) Patent Application Publication
(10) Pub. No.: US 2018/0147630 A1
(43) Pub. Date: May 31, 2018

(54) COMPOSITE FOR WEAR-RESISTANT RING HAVING EXCELLENT HEAT CONDUCTIVITY

(71) Applicants: NIPPON PISTON RING CO., LTD., Saitam (JP); Honda Motor Co.,Ltd., Tokyo (JP)

(72) Inventors: Hiroshi TAKIGUCHI, Tochigi (JP); Atsuya AOKI, Tochigi (JP); Ryo WAKABAYASHI, Saitama (JP); Ryohei IKUTOMO, Saitama (JP); Akito TANIHATA, Saitama (JP)

(73) Assignee: Honda Motor Co.,Ltd., Tokyo (JP)

(21) Appl. No.: 15/577,342

(22) PCT Filed: Jun. 15, 2016
(86) PCT No.: PCT/JP2016/067812

§ 371 Date: Nov. 28, 2017

(30) Foreign Application Priority Data
Jul. 1, 2015 (JP) 2015-132843

(51) Int. Cl. B22F 7/00; C22C 38/16; C22C 38/00; B22F 5/02; B22F 3/26

(52) U.S. Cl. CPC B22F 7/008; C22C 38/16; F16J 9/26; B22F 5/02; B22F 3/26; C22C 38/00

(57) ABSTRACT

Provided is a composite for a wear-resistant ring having excellent heat conductivity. In the composite for a wear-resistant ring, an iron-based sintered compact for a wear-resistant ring having a composition that contains, by mass, C of 0.4 to 1.5% and Cu of 20 to 40%, and having a structure in which pores exist continuously at a porosity of 15 to 50% in terms of volume fraction, and in which a matrix is pearlite, and in which a free Cu phase or further dispersion particles are dispersed in the matrix, is insert-cast in an aluminum alloy, and has the pores impregnated with the aluminum alloy.

### TECHNICAL FIELD

The present invention relates to an iron-based sintered compact suitable for a wear-resistant ring used in an internal combustion engine for an automobile or the like, and particularly, to a composite for a wear-resistant ring obtained by insert-casting an iron-based sintered compact for a wear-resistant ring in an aluminum alloy.

### RELATED ART

In recent years, improvements in fuel efficiency of automobiles or the like have been strongly requested in view of the preservation of global environment. In response to such requests, engine weight is being reduced, and aluminum alloy engines are becoming more common. However, aluminum alloys have lower wear resistance than conventional cast iron, and an improvement in wear resistance is required in the aluminum alloy engine, particularly a sliding part that slides at a high temperature.

Regarding this problem, an aluminum piston having a structure in which a wear-resistant ring made of a material having higher strength than an aluminum alloy (a piston material) is insert-cast in a piston ring groove and a piston ring is supported by the wear-resistant ring has been used since long ago. As the wear-resistant ring insert-cast in this aluminum piston, a Ni-resist cast iron wear-resistant ring subjected to aluminum plating treatment (Al-fin treatment or the like) is generally used. The wear-resistant ring subjected to Al-fin treatment is insert-cast in the aluminum alloy, and thereby bonding strength between the wear-resistant ring and the aluminum alloy can be improved.

Recently, use of a porous metal sintered compact as a high-strength material serving as a reinforcement (a wear-resistant ring) for an aluminum alloy member instead of Ni-resist cast iron has been proposed.

For example, in Patent Literature 1, a metal sintered compact composite material including an iron-based porous metal sintered compact that has a three-dimensional lattice structure with pores and a light metal that is impregnated and solidified into the pores of the porous metal sintered compact and in which a metal of which the porous metal sintered compact is made is set to HV 200 to 800 in micro-Vickers hardness is proposed. In the technology described in Patent Literature 1, a powder compact formed using an iron-based raw material powder having a composition of at least one of Cr, Mo, V, W, Mn, or Si at 2 to 70% by weight, C at 0.07 to 8.2% by weight, and a balance of Fe with inevitable impurities is sintered and formed into an iron-based porous metal sintered compact having a composition that has a three-dimensional lattice structure having pores and a volume fraction of 30 to 88% and that can be quenched with a gas, and the porous metal sintered compact is formed into a composite by impregnating the pores of the porous metal sintered compact with a melt of a light metal after the gas quenching of cooling the porous metal sintered compact in the gas is carried out and solidifying the impregnated porous metal sintered compact.

In Patent Literature 2, an aluminum alloy piston for an internal combustion engine including a support member constituting a piston ring groove is described. In the piston described in Patent Literature 2, an austenitic stainless steel porous body having a relative density of 50 to 80% is used as the support member, and the support member is insert-cast in an aluminum alloy of which a piston main body is formed.

In Patent Literature 3, a porous metal sintered compact for reinforcing a light alloy member is described. The porous metal sintered compact described in Patent Literature 3 is a porous metal sintered compact that is formed by compacting and sintering mixed powder that contains alloy powder, and has impregnability of a light metal which has a porosity of 15 to 50%, in which pores whose diameters exceed 5 μm make up 80% or more of the entire porosity, and which has a radial crushing strength of 200 MPa or more. In the technology described in Patent Literature, the porous metal sintered compact is preferably used as a porous stainless steel sintered compact or a porous Fe—Cu—C sintered compact. The porous Fe—Cu—C sintered compact preferably contains Cu at 2 to 6% by mass.

### LITERATURE LIST

### Patent Literature

Patent Literature 1:

Japanese Unexamined Patent Application Publication No. H08-319504

Patent Literature 2:

Japanese Unexamined Patent Application Publication No. 2001-32747

Patent Literature 3:

Japanese Unexamined Patent Application Publication No. 2003-73755

### SUMMARY OF THE INVENTION

### Technical Problem

However, in the technology described in Patent Literature 1, the alloy elements of Cr, Mo, V, etc. are contained in large quantities such that the gas quenching is possible, and are economically unfavorable as the materials insert-cast in the light alloy due to their high prices. In the composite described in Patent Literature 1, there is a problem that thermal conductivity is low and that heat shrinkage is insufficient. In the technology described in Patent Literature 2, the support member is formed of austenitic stainless steel and contains alloy elements of Cr, Ni, etc. in large quantities, which leads to a high price, and there is a problem that thermal conductivity is low, and especially that heat shrinkage has become insufficient as a member for a high-load engine in recent years. In the technology described in Patent Literature 3, when the porous metal sintered compact is used as the porous stainless steel sintered compact, it contains alloy elements of Cr, Ni, etc. in large quantities, which leads to a high price, and has low thermal conductivity. For this reason, there is a problem that heat shrinkage is insufficient as a member for a high-load engine in recent years. When the porous metal sintered compact is used as the porous Fe—Cu—C sintered compact containing Cu at 2 to 6%, which is a small quantity, there is a problem that heat shrinkage is insufficient as the composite.

An object of the present invention is to provide a composite for a wear-resistant ring having excellent heat conductivity, which solves the problems of the related arts, is formed by insert-casting an iron-based sintered compact for a wear-resistant ring, which is suitable for reinforcing an aluminum alloy member such as an engine or the like, in an aluminum alloy, has a radial crushing strength of 300 MPa or more and a thermal conductivity of 40 W/m/K or more.

### Solution to Problem

The inventors of the present invention made a keen study of various factors influencing the heat conductivity of the composite formed by insert-casting the iron-based sintered compact in the aluminum alloy in order to achieve the aforementioned object. As a result, the inventors thought to use the iron-based sintered compact to be used as an iron-based sintered compact that had continuous pores at a porosity of 15 to 50%, contained Cu, and had a structure in which the free Cu phase was dispersed in the matrix. However, with intent to improve the thermal conductivity of the composite, although a content of Cu or an amount of impregnation of the aluminum alloy having a high thermal conductivity was increased, a remarkable increase in the thermal conductivity of the composite was not recognized up to a certain range. Furthermore, increasing the content of Cu or the amount of impregnation of the aluminum alloy beyond the certain range led to a reduction in the strength of the composite.

Therefore, as a result of further study, the inventors discovered that the heat conductivity of the matrix phase of the iron-based sintered compact had a great influence on the heat conductivity of the composite, and conceived that it was effective to use the iron-based sintered compact having a structure that is a pearlite matrix having relatively high thermal conductivity. However, since the pearlite matrix has a lower linear expansion coefficient than an austenite matrix, a great expansion difference is probable in a boundary surface (an interface) between the aluminum alloy and the sintered compact due to a thermal load when insert-cast in the aluminum alloy during production of the composite or during actual use, and results in peeling off or the like. However, the inventors discovered that, if the boundary strength between the iron-based sintered compact and the aluminum alloy could be increased more than a constant value, the iron-based sintered compact could be prevented from peeling off or the like during insert-casting or during perform despite a relatively low linear expansion coefficient.

Therefore, as a result of further study, the inventors found that, if the material of the wear-resistant ring insert-cast in the aluminum alloy was the iron-based sintered compact having the continuous pores at a porosity of 15 to 50% and the structure in which the free Cu phase was dispersed in the pearlite matrix, the boundary strength with respect to the aluminum alloy could be increased more than a certain constant value in the composite insert-cast in the aluminum alloy.

It was found that the composite for a wear-resistant ring having this constitution was remarkably improved in heat conductivity while having a desired radial crushing strength and could be further prevented from peeling off during production or during actual use because the boundary strength with respect to the aluminum alloy was high in spite of having a relatively low linear expansion coefficient.

The present invention was completed by adding a further study on the basis of such a finding. That is, the gist of the present invention is as follows.

(1) A composite for a wear-resistant ring having excellent heat conductivity, which is formed by insert-casing an iron-based sintered compact for a wear-resistant ring in an aluminum alloy, wherein: the iron-based sintered compact for a wear-resistant ring is an iron-based sintered compact having a composition that contains, by mass, C of 0.4 to 1.5% and Cu of 20 to 40% and is composed of a balance of Fe and inevitable impurities, and a structure in which pores exist continuously at a porosity of 15 to 50% in terms of volume fraction, and in which a matrix is pearlite, and in which a free Cu phase is dispersed in the matrix; the aluminum alloy is impregnated into the pores; a thermal conductivity is more than or equal to 40 W/m/K and a radial crushing strength is more than or equal to 300 MPa.

(2) In the composite for a wear-resistant ring of (1), in addition to the thermal conductivity and the radial crushing strength, a linear expansion coefficient from room temperature to 300° C. is 13.6 to 16.9×10⁻⁶/K, and a boundary strength with respect to the aluminum alloy is higher than or equal to 1.5 times a boundary strength with respect to an aluminum alloy of a composite formed by insert-casting a wear-resistant ring made of Ni-resist cast iron subjected to aluminum plating treatment in the aluminum alloy.

(3) In the composite for a wear-resistant ring of (1) or (2), the structure of the iron-based sintered compact for a wear-resistant ring is a structure in which, in addition to the free Cu phase, dispersion particles containing Mo or Si are further dispersed in the matrix at a total of 2% by mass or less.

(4) A method of producing a composite for a wear-resistant ring that is used as a composite for a wear-resistant ring in which an iron-based sintered compact for a wear-resistant ring is mounted at a predetermined site of a mold, in which a melt of an aluminum alloy is injected into the mold, and in which the iron-based sintered compact for a wear-resistant ring is insert-cast in the melt, the method comprising: causing Cu powder of 20 to 40%, graphite powder of 0.4 to 1.5%, or powder for dispersion particles of 2.0% by mass or less with respect to a total amount of iron-based powder, graphite powder, Cu powder, and powder for dispersion particles, and lubricant powder of 0.3 to 3.0 parts by mass with respect to 100 parts by mass that are the total amount of the iron-based powder, the graphite powder, the Cu powder, and the powder of dispersion particles to be blended, mixed, and kneaded with the iron-based powder to obtain mixed powder; further charging and compacting the mixed powder in a mold to obtain a substantially equal compact in a predetermined shape; and sintering the compact to obtain an iron-based sintered compact of a predetermined shape which has a composition that contains, by mass, C of 0.4 to 1.5% and Cu of 20 to 40% and is composed of a balance of Fe and inevitable impurities, and a structure in which pores exist continuously at a porosity of 15 to 50% in terms of volume fraction, and in which a matrix is pearlite, and in which a free Cu phase and further dispersion particles of 2% or less by mass are dispersed in the matrix; and using the iron-based sintered compact as the iron-based sintered compact for a wear ring to obtain the composite for a wear-resistant ring as a composite in which the aluminum alloy is impregnated into the pores, a thermal conductivity is more than or equal to 40 W/m/K and a radial crushing strength is more than or equal to 300 MPa.

(5) In the method of (4), the iron-based powder has particle size distribution in which particles pass through a 60-mesh sieve and do not pass through a 350-mesh sieve.

(6) In the method of (4) or (5), Fe—Cu alloy powder is replaced with the iron-based powder and the Cu powder.

(7) In the method of any one of (4) to (6), the sintering is a treatment that is carried out at a sintering temperature of 1000 to 1200° C.

(8) In the method of any one of (4) to (7), the composite for a wear-resistant ring is further configured such that a linear expansion coefficient from room temperature to 300° C. is 13.6 to 16.9×10⁻⁶/K, and a boundary strength with respect to the aluminum alloy is higher than or equal to 1.5 times a boundary strength with respect to an aluminum alloy of a composite formed by insert-casting a wear-resistant ring made of Ni-resist cast iron subjected to aluminum plating treatment in the aluminum alloy.

(9) In the method of any one of (4) to (8), the dispersion particles are dispersion particles containing Mo or Si.

### Advantageous Effects of Invention

According to the present invention, a composite for a wear-resistant ring having an excellent radial crushing strength, a high thermal conductivity, and an excellent heat conductivity (heat shrinkage) can be stably produced, and exhibits a drastic industrial effect. According to the present invention, there is also an effect that a reduction in weight of an automobile or the like can be further accelerated.

### DESCRIPTION OF THE EMBODIMENTS

A composite for a wear-resistant ring of the present invention is either a composite obtained by insert-casting an iron-based sintered compact for a wear-resistant ring in an aluminum alloy or a composite obtained by impregnating an iron-based sintered compact for a wear-resistant ring with an aluminum alloy. Therefore, the aluminum alloy is impregnated into pores of the iron-based sintered compact.

In the composite for a wear-resistant ring of the present invention, the iron-based sintered compact for a wear-resistant ring which is insert-cast in the aluminum alloy is used as an iron-based sintered compact which has a composition that contains, by mass, C of 0.4 to 1.5% and Cu of 20 to 40% and is composed of a balance of Fe and inevitable impurities, and a structure in which pores exist continuously at a porosity of 15 to 50% in terms of volume fraction, in which a matrix is pearlite, and in which a free Cu phase or further dispersion particles containing Mo or Si are dispersed in the matrix at a total of 2% by mass or less with respect to a total amount of the sintered compact.

First, a reason for the restrictions on the composition of the iron-based sintered compact for a wear-resistant ring which is insert-cast in the aluminum alloy or is impregnated with the aluminum alloy will be described. Hereinafter, the mass percent in the composition is simply expressed as %.

C: 0.4 to 1.5%

C is an element for increasing a strength and hardness of the sintered compact, and is required to have a content of 0.4% or more in order to secure a desired strength and to make a matrix into a pearlite structure that is rich in cuttability (machinability) and is good in heat conductivity. Meanwhile, in the case of a content exceeding 1.5%, carbide is coarsened, while the cuttability (the machinability), the heat conductivity, and the strength are reduced. For this reason, C is limited to a range of 0.4 to 1.5%.

Cu: 20 to 40%

Cu is dissolved in a solid phase to increase the strength of the sintered compact, is dispersed in a matrix phase as a free Cu phase and in pores, and reacts with the aluminum alloy to increase a bonding strength (a boundary strength) between the iron-based sintered compact and the aluminum alloy (the aluminum alloy member) when insert-cast in the aluminum alloy. When a content of Cu is less than 20%, a thermal conductivity cannot be set to 40 W/m/K or more. On the other hand, when Cu exceeds 40% and is contained in large quantities, mechanical properties such as a strength or the like of the composite are reduced. For this reason, Cu is limited to a range of 20 to 40%. Cu is preferably 25 to 35%.

It goes without saying that the sintered compact in which the dispersion particles containing Mo or Si are further dispersed in addition to the aforementioned free Cu phase has a composition that contains Mo or Si in addition to although an amount of dispersion of dispersion particles other than C and Cu is not specifically indicated separately.

The balance excluding the above components is composed of Fe and inevitable impurities.

Next, a reason for the restrictions on the structure of the iron-based sintered compact for a wear-resistant ring which is used in the present invention will be described.

The matrix of the iron-based sintered compact for a wear-resistant ring which is used in the present invention is pearlite.

Among the matrix structures such as ferrite, martensite and the like, the pearlite matrix has good cuttability and high thermal conductivity. For this reason, in the present invention, the matrix of the iron-based sintered compact is limited to the pearlite.

The iron-based sintered compact for a wear-resistant ring which is used in the present invention has a structure in which the free Cu phase or also including the dispersion particles containing Mo or Si are dispersed in the matrix.

The free Cu phase functions to react with the aluminum alloy impregnated into the pores when the composite is produced, and to strongly bond the aluminum alloy and the iron-based sintered compact. If the Cu content is within a scope of the present invention, a tendency to increase the bonding strength (the boundary strength) and to improve the heat conductivity is shown. An amount of dispersion of the free Cu phase is fixed depending on the Cu content of the iron-based sintered compact or an amount of alloy elements contained additionally, and thus does not need to be especially limited. In the composition range of the iron-based sintered compact used in the present invention, Cu is contained more than the limit of solid solubility, and is dispersed greatly as the free Cu phase.

Both of Mo and Si show a tendency to have a higher thermal conductivity than Fe, are elements contributing to improvement of the thermal conductivity, and disperse the dispersion particles containing Mo or Si in order to improve, especially, the thermal conductivity.

To obtain these effects, the dispersion particles containing Mo or Si are dispersed in the sintered compact at a total of 2% by mass or less. When the dispersion particles containing Mo or Si are increased more than a total of 2% by mass, sinterability and a composite characteristic are reduced. The dispersion particles containing Mo or Si are caused by blending powder for the dispersion particles in addition to iron-based powder. A part of the blended powder containing Mo or Si is merely dissolved in a solid phase, so that most of the blended powder containing Mo or Si is dispersed in the matrix phase as the dispersion particles containing Mo or Si and is present in the sintered compact. As the dispersion particles containing Mo or Si, Mo particles, Fe—Mo particles, Fe—Si particles, SiC particles, etc. can be given as examples. The dispersion particles having a higher thermal conductivity than Fe are dispersed, and thereby the thermal conductivity of the composite can be improved to some extent.

Further, the iron-based sintered compact used for the composite of the present invention is a sintered compact having a porosity of 15 to 50% in terms of volume fraction.

Porosity: 15 to 50%

In a case in which a porosity is less than 15%, when the iron-based sintered compact is insert-cast in the aluminum alloy or when the aluminum alloy is impregnated, a melt of the aluminum alloy is not sufficiently impregnated into the pores, and the bonding strength is reduced. Meanwhile, when the porosity exceeds 50%, the pores are excessive and the strength is reduced, which causes a reduction in strength. For this reason, the porosity of the iron-based sintered compact to be used is limited to a range of 15 to 50% in terms of volume fraction, and preferably ranges from 25 to 35%.

“Porosity” as used herein is a full porosity, and is obtained by converting a density measured by an Archimedes method.

In the iron-based sintered compact used for the composite of the present invention, to impregnate the aluminum alloy into the pores, the pores need to exist continuously. The expression “pores exist continuously” used herein shall represent a case in which a ratio of an amount of continuous pores to an amount of all pores (={(Amount of continuous pores)/(Amount of all pores)}×100%) exceeds 50. “Amount of all pores” as used herein is obtained by converting the density measured by the Archimedes method. In addition, “amount of continuous pores” is an amount of continuous pores set by immersing the sintered compact in liquid wax or the like for 69 minutes, causing the wax or the like to permeate the sintered compact, converting a variation in weight before and after the permeation, and obtaining that variation.

Next, a preferred method of producing the iron-based sintered compact for a wear-resistant ring which is used for the composite of the present invention will be described.

After iron powder (iron-based powder), Cu powder, graphite powder, or powder for the dispersion particles, and lubricant powder are mixed to become mixed powder, the mixed powder is formed into a compact having a predetermined shape for a wear-resistant ring. The obtained compact is sintered into an iron-based sintered compact for a wear-resistant ring. The iron powder (the iron-based powder) and the Cu powder may be replaced with Fe—Cu alloy powder. The Fe—Cu alloy powder may contain powder in which Cu is locally alloyed around the iron powder.

It is needless to say that a blending amount of the Cu powder or the Fe—Cu alloy powder is adjusted to correspond to a Cu content (20 to 40% by mass) of the iron-based sintered compact.

To disperse the dispersion particles containing Mo or Si in the sintered compact, powder for dispersion particles containing Mo or Si is preferably blended at a total of 2% by mass or less with respect to a total amount of the sintered compact. The powder containing Mo or Si is preferably Mo powder, Fe—Mo powder, Fe—Si powder, or SiC powder, but of course it is not limited thereto.

The iron-based powder (the iron powder or the Fe—Cu alloy powder) is used as powder adjusted in particle size distribution in which particles pass through a 60-mesh sieve (hereinafter referred to as finer than 60 mesh or −60 mesh) and do not pass through a 350-mesh sieve (hereinafter referred to as coarser than 350 mesh or +350 mesh).

When particles of +60 mesh are present, compactibility of the mixed powder is reduced. On the other hand, when particles of −350 mesh are present, the continuous pores are hardly formed, and an impregnation characteristic of the aluminum alloy is reduced. If particles of −60 to +100 mesh is less than 40% of the whole powder, this is advantageous to make a compact having a desired porosity.

The iron-based powder (the iron powder or the Fe—Cu alloy powder) having the particle size distribution as described above, the Cu powder, and the powder for the dispersion particles are further mixed along with the graphite powder and the lubricant powder, and are used as the mixed powder.

The graphite powder is blended to adjust the C content of the iron-based sintered compact. A blending ratio is preferably set to 0.4 to 1.5% by mass with respect to a total amount of the iron-based powder, the graphite powder, the Cu powder, and the dispersion particle powder. When the blending ratio is less than 0.4%, it is difficult to secure a desired strength. When the blending ratio exceeds 1.5%, carbide is coarsened, the cuttability, the heat conductivity, and the strength are reduced. A particle diameter of the graphite powder is preferably set to 0.1 to 10 μm. When the particle diameter is less than 0.1 μm, treatment is difficult. On the other hand, when the particle diameter exceeds 10 μm, uniform dispersion is difficult.

The lubricant powder is contained in the mixed powder to improve formability when the compact is formed and to increase a green density. As the lubricant powder, common lubricant powder such as zinc stearate or the like is suitable. A blending amount in the mixed powder is preferably set to 0.3 to 3.0 parts by mass with respect to 100 parts by mass of the total amount of the iron-based powder, the graphite powder, the Cu powder, and the powder for the dispersion particles.

This mixed powder is charged into a mold, is formed under pressure to become a compact having a shape substantially equal to a predetermined shape. A method of forming the compact does not need to be especially limited, but preferably uses a forming press or the like. The formed compact is subsequently sintered into an iron-based sintered compact having a predetermined shape. Sintering conditions are preferably adjusted to have a porosity of 15 to 50% in terms of volume fraction.

The sintering is preferably conducted in an inert gas atmosphere or a non-oxidizing atmosphere at a sintering temperature of 1000 to 1200° C.

Further, the iron-based sintered compact for a wear-resistant ring which is obtained in this way is mounted at a corresponding site in a mold for forming an aluminum alloy member, and a melt of the aluminum alloy is injected into the mold and is subjected to high-pressure die casting or melt forging, so that a composite for a wear-resistant ring (an aluminum alloy member) in which the iron-based sintered compact for a wear-resistant ring is insert-cast is preferably obtained.

As the aluminum alloy injected into the composite by high-pressure die casting or the like member, any of common aluminum alloys such as AC8A, ADC12, etc. can be applied. There is no problem with applying a hypereutectic Si-based aluminum alloy such as AC9A.

The composite for a wear-resistant ring obtained in the way becomes a composite for a wear-resistant ring in which the aluminum alloy is impregnated into the pores, in which the free Cu phase or further the dispersion particles are dispersed in the matrix, and which has a thermal conductivity of 40 W/m/K or more, a radial crushing strength of 300 MPa or more, an excellent heat conductivity, an excellent heat shrinkage, and an improved high-temperature wear resistance. The obtained composite for a wear-resistant ring becomes a composite which has a linear expansion coefficient that is 13.6 to 16.9×10⁻⁶/K from room temperature to 300° C. on average and a boundary strength a with respect to the aluminum alloy is 1.5 times or higher than a boundary strength σ_{E} with respect to the aluminum alloy of the composite obtained by insert-casting Ni-resist cast iron subjected to aluminum plating treatment in the aluminum alloy, and which has a high bonding strength and the peeling off during production and actual use can be prevented. The boundary strength σ_{E} with respect to the aluminum alloy of the composite obtained by insert-casting the Ni-resist cast iron subjected to aluminum plating treatment in the aluminum alloy typically shows about 30 MPa.

Hereinafter the present invention will be further described on the basis of examples.

### EXAMPLES

Cu powder, graphite powder, or further powder for dispersion particles of types shown in Table 1 were blended into pure iron powder adjusted as iron-based powder in particle size distribution in which particles passed through a 60-mesh sieve and did not pass through a 350-mesh sieve at a blending amount (% by mass) shown in Table 1, and lubricant particle powder was further blended at a blending amount (parts by mass) shown in Table 1 and was mixed into mixed powder by a mixer. An average particle diameter of the graphite powder, the Cu powder, the powder for dispersion particles was set to 150 μm or less.

The obtained mixed powder was charged into a mold, and was formed into a compact having a ring shape (outer diameter ϕ90 mm×inner diameter ϕ60 mm×thickness 5 mm) by a forming press. Next, the obtained compact was subjected to sintering treatment, and was formed into an iron-based sintered compact for a wear-resistant ring. The sintering treatment was conducted in a nitrogen gas atmosphere at a temperature ranging from 1000 to 1200° C.

A test piece was taken from the obtained iron-based sintered compact for a wear-resistant ring, a composition and porosity of the sintered compact were measured to observe a structure. The porosity was converted from a density measured by an Archimedes method. It was checked whether existing pores were “continuous pores.” The sintered compact was immersed in liquid was or the like for 60 minutes, caused the wax or the like to permeate the sintered compact, and was converted from a variation in weight before and after the permeation. That variation was obtained and set to an amount of the continuous pores. A value defined by a formula as follows was calculated:

Ratio of amount of continuous pores (={(Amount of continuous pores)/(Amount of all pores)}×100%)

It was evaluated that a case in which the ratio exceeds 50 was the “continuous pores.” Here, a total amount of the pores was converted from the density obtained the Archimedes method.

For the structure, the test piece for observing the structure was taken from the iron-based sintered compact, a cross section thereof in a pressing direction was polished and etched (an etchant: a natal solution), and identification of a matrix phase structure and the presence or absence of the free Cu phase and the dispersion particles were observed by an optical microscope. Further, amounts of dispersion of the free Cu phase and the dispersion particles were measured. For the amounts of dispersion, an area ratio between the free Cu phase and the dispersion particles was measured by a surface analysis using EPMA, and was converted into an area ratio with respect to the entire matrix phase. In regard to the dispersion particles, the amount of dispersion was further converted from the obtained area ratio with respect to the entire matrix phase into the mass % with respect to the total amount of the sintered compact.

The obtained results are shown in Table 2.

Any of the iron-based sintered compacts used in the examples of the present invention is the sintered compact that has a composition that contains C of 0.4 to 1.5% and Cu of 20 to 40% and a structure in which the matrix is a pearlite matrix and the free Cu phase or further the dispersion particles are dispersed in the matrix, and that has the continuous pores at a porosity of 15 to 50%. Meanwhile, comparative examples are sintered compacts in which C and/or Cu is out of the scope of the present invention, and the matrix is a pearlite matrix containing ferrite or cementite, the free Cu phase is not dispersed in the matrix, the porosity deviates from the scope of the present invention or does not become the continuous pores, or the dispersion particles deviate from the scope of the present invention.

In regard to the sintered compacts (Nos. 25 to 29) in which the dispersion particles containing Mo or Si are dispersed, amounts of Mo and Si are not given to the column of the chemical component of the sintered compact. It goes without saying that the sintered compact contains the amount of Mo or the amount of Si corresponding to the amount of dispersion of the dispersion particles.

Next, the obtained iron-based sintered compact for a wear-resistant ring was mounted at a predetermined position in the mold for forming the aluminum alloy member, and a melt of the aluminum alloy (having the composition of JIS AC8A) was injected into the mold under high pressure by die casting, so that the composite for a wear-resistant ring in which the iron-based sintered compact for a wear-resistant ring is insert-cast was obtained. When the porosity was low, the aluminum alloy cannot be sufficiently impregnated, and the composite cannot be obtained.

A test piece was taken from the obtained composite for a wear-resistant ring, and the thermal conductivity, the linear expansion, the radial crushing strength, and the boundary strength were measured. A test method is as follows.

(1) Measurement of Thermal Conductivity

A test piece (size: (ϕ10 mm×thickness 3 mm) for measuring the thermal conductivity was taken from the obtained composite for a wear-resistant ring, and the thermal conductivity was measured at room temperature by a laser flash method.

(2) Measurement of Linear Expansion

A linear expansion test piece (size: 2 mm×2 mm×length 20 mm) was taken from the obtained composite for a wear-resistant ring, and the linear expansion was measured from room temperature to 300° C. by a linear expansion measuring device, and an average linear expansion coefficient between room temperature and 300° C. was obtained.

(3) Measurement of Radial Crushing Strength

A test piece (outer diameter ϕ85 mm×inner diameter 4.65 mm×thickness 4 mm) for measuring the radial crushing strength was taken from the obtained composite for a wear-resistant ring, a radial crushing strength test was carried out in conformity with the regulation of JIS Z 2507, and the radial crushing strength of the composite was measured.

(4) Measurement of Boundary Strength (Bonding Strength)

A tensile test piece (size: 8 mm×3 mm×length 10 mm) containing a bonding boundary between the aluminum alloy and the composite was taken from the obtained composite for a wear-resistant ring, a tension test was carried out, and the boundary strength (bonding strength) σ was obtained. A direction in which the tensile test piece was taken was set to a direction containing an interface at a right angle to an axis of the test piece. The boundary strength σ was evaluated by the ratio to the boundary strength σ_{E} (boundary strength ratio), σ/σ_{E}, when the wear-resistant ring made of Ni-resist cast iron subjected to aluminum plating treatment (Al-fin treatment) was insert-cast in the aluminum alloy. σ_{E} was 30 MPa.

The obtained results are shown in Table 2 together.

TABLE 1

| | Mixed powder | | | | | | |
|---|---|---|---|---|---|---|---|
| | | | | Powder for | | | |
| | Iron-based | | | dispersion | | | |
| | powder* | Graphite powder | Cu powder | particles | | | |
| | Type*: Blending | Blending | Blending | Type**: Blending | Lubricant particle powder | | |
| Mixed powder | amount | amount | amount | amount | | Blending amount**** | |
| No. | (% by mass) | (% by mass) | (% by mass) | (% by mass) | Type*** | (parts by mass) | Remarks |
| 1 | A: 99.0 | 1.0 | — | — | a | 1.0 | Comparative example |
| 2 | A: 95.0 | 1.0 | 4 | — | a | 1.0 | Comparative example |
| 3 | A: 95.5 | 0.5 | 4 | — | a | 1.0 | Comparative example |
| 4 | A: 89.0 | 1.0 | 10 | — | a | 1.0 | Comparative example |
| 5 | A: 79.0 | 1.0 | 20 | — | a | 1.0 | Preferred example |
| 6 | A: 78.5 | 1.5 | 20 | — | a | 1.0 | Preferred example |
| 7 | A: 74.0 | 1.0 | 25 | — | a | 1.0 | Preferred example |
| 8 | A: 69.0 | 1.0 | 30 | — | a | 1.0 | Preferred example |
| 9 | A: 64.1 | 0.9 | 35 | — | a | 1.0 | Preferred example |
| 10 | A: 59.2 | 0.8 | 40 | — | a | 1.0 | Preferred example |
| 11 | A: 59.7 | 0.3 | 40 | — | a | 1.0 | Comparative example |
| 12 | A: 59.5 | 0.5 | 40 | — | a | 1.0 | Preferred example |
| 13 | A: 54.3 | 0.7 | 45 | — | a | 1.0 | Comparative example |
| 14 | A: 69.2 | 0.8 | 30 | — | a | 1.0 | Preferred example |
| 15 | A: 68.3 | 1.7 | 30 | — | a | 1.0 | Comparative example |
| 16 | A: 67.0 | 1.0 | 30 | w: 2.0 | a | 1.0 | Preferred example |
| 17 | A: 67.5 | 1.0 | 30 | x: 1.5 | a | 1.0 | Preferred example |
| 18 | A: 66.0 | 1.0 | 30 | x: 3.0 | a | 1.0 | Comparative example |
| 19 | A: 68.0 | 1.0 | 30 | y: 1.0 | a | 1.0 | Preferred example |
| 20 | A: 68.0 | 1.0 | 30 | z: 1.0 | a | 1.0 | Preferred example |

*A: Pure iron powder
**w: Mo powder, x: 60% Fe—Mo powder, y: 45% Fe—Si powder, z: SiC powder
***a: Zinc stearate powder
****(iron-based powder + powder for dispersion particles + Cu powder + graphite powder): 100 parts by mass

TABLE 2

| | | Sintered compact | | | | | | | | | Composite | | | | |
|---|---|---|---|---|---|---|---|---|---|---|---|---|---|---|---|
| | | | | | | | | Composition | | | | | Linear | | |
| | | | | | | | | | Free Cu | Dispersion | | Heat | expansion | | |
| | | | | | | Porosity | | | phase | particle | Radial | conductivity | Linear | | |
| | Sintered | Mixed | Chemical component (% | | | Porosity | | | Amount of | Amount of | crushing | Thermal | expansion | Boundary | |
| Composite | compact | powder | by mass) | | | (% by | Continuous | Matrix | dispersion | dispersion | strength | conductivity | coefficient | strength | |
| No. | No. | No. | C | Cu | Balance | volume) | pore* | phase** | (% by area) | (% by mass) | (MPa) | (W/m/K) | (K⁻¹) | ratio*** | Remarks |
| 1 | 1 | 1 | 1.0 | — | Fe | 34 | ◯ | P | — | — | 360 | 27 | 11.7 | 0.9 | Comparative |
| | | | | | | | | | | | | | | | example |
| 2 | 2 | 2 | 1.0 | 4 | Fe | 33 | ◯ | P | — | — | 380 | 30 | 11.8 | 1.1 | Comparative |
| | | | | | | | | | | | | | | | example |
| 3 | 3 | 3 | 0.5 | 4 | Fe | 35 | ◯ | P + F | 1 | — | 260 | 29 | 11.9 | 1.0 | Comparative |
| | | | | | | | | | | | | | | | example |
| 4 | 4 | 4 | 1.0 | 10 | Fe | 29 | ◯ | P | 8 | — | 408 | 37 | 12.5 | 1.4 | Comparative |
| | | | | | | | | | | | | | | | example |
| 5 | 5 | 5 | 1.0 | 20 | Fe | 22 | ◯ | P | 18 | — | 376 | 41 | 13.6 | 1.7 | Example |
| 6 | 6 | 6 | 1.5 | 20 | Fe | 22 | ◯ | P | 18 | — | 365 | 42 | 13.8 | 1.8 | Example |
| 7 | 7 | 7 | 1.0 | 25 | Fe | 32 | ◯ | P | 22 | — | 326 | 46 | 14.3 | 2.8 | Example |
| 8 | 8 | 7 | 1.0 | 25 | Fe | 27 | ◯ | P | 23 | — | 424 | 47 | 14.6 | 2.2 | Example |
| 9 | 9 | 8 | 1.0 | 30 | Fe | 31 | ◯ | P | 27 | — | 340 | 47 | 14.7 | 3.0 | Example |
| 10 | 10 | 8 | 1.0 | 30 | Fe | 26 | ◯ | P | 28 | — | 444 | 54 | 15.1 | 2.4 | Example |
| 11 | 11 | 8 | 1.0 | 30 | Fe | 14 | X | P | 28 | — | Cannot be formed into composite | | | | Comparative |
| | | | | | | | | | | | | | | | example |
| 12 | 12 | 8 | 1.0 | 30 | Fe | 41 | ◯ | P | 28 | — | 311 | 44 | 16.1 | 3.2 | Example |
| 13 | 11 | 8 | 1.0 | 30 | Fe | 53 | ◯ | P | 27 | — | 240 | 40 | 16.3 | 3.3 | Comparative |
| | | | | | | | | | | | | | | | example |
| 14 | 14 | 8 | 1.0 | 30 | Fe | 10 | X | P | 28 | — | Cannot be formed into composite | | | | Comparative |
| | | | | | | | | | | | | | | | example |
| 15 | 15 | 9 | 0.9 | 35 | Fe | 30 | ◯ | P | 33 | — | 353 | 51 | 15.1 | 3.1 | Example |
| 16 | 16 | 9 | 0.9 | 35 | Fe | 25 | ◯ | P | 32 | — | 440 | 54 | 15.0 | 2.6 | Example |
| 17 | 17 | 9 | 0.9 | 35 | Fe | 20 | ◯ | P | 33 | — | 525 | 55 | 14.5 | 1.8 | Example |
| 18 | 18 | 10 | 0.8 | 40 | Fe | 31 | ◯ | P | 38 | — | 310 | 60 | 15.3 | 3.1 | Example |
| 19 | 19 | 10 | 0.8 | 40 | Fe | 45 | ◯ | P | 37 | — | 301 | 50 | 16.5 | 3.2 | Example |
| 20 | 20 | 11 | 0.3 | 40 | Fe | 35 | ◯ | P + F | 37 | — | 270 | 43 | 15.0 | 3.3 | Comparative |
| | | | | | | | | | | | | | | | example |
| 21 | 21 | 12 | 0.5 | 40 | Fe | 30 | ◯ | P | 38 | — | 305 | 52 | 15.3 | 2.9 | Example |
| 22 | 22 | 13 | 0.7 | 45 | Fe | 35 | ◯ | P | 42 | — | 180 | 62 | 15.9 | 3.1 | Comparative |
| | | | | | | | | | | | | | | | example |
| 23 | 23 | 14 | 0.8 | 30 | Fe | 31 | ◯ | P | 26 | — | 330 | 47 | 14.7 | 2.9 | Example |
| 24 | 24 | 15 | 1.7 | 30 | Fe | 31 | ◯ | P + C | 28 | — | 295 | 42 | 14.2 | 2.7 | Comparative |
| | | | | | | | | | | | | | | | example |
| 25 | 25 | 16 | 1.0 | 30 | Fe | 30 | ◯ | P | 25 | 1.9 | 370 | 51 | 14.2 | 2.2 | Example |
| 26 | 26 | 17 | 1.0 | 30 | Fe | 31 | ◯ | P | 26 | 1.5 | 330 | 48 | 14.3 | 1.9 | Example |
| 27 | 27 | 18 | 1.0 | 30 | Fe | 31 | ◯ | P | 24 | 3.0 | 310 | 49 | 14.2 | 1.4 | Comparative |
| | | | | | | | | | | | | | | | example |
| 28 | 28 | 19 | 1.0 | 30 | Fe | 31 | ◯ | P | 27 | 0.9 | 325 | 48 | 14.1 | 1.7 | Example |
| 29 | 29 | 20 | 1.5 | 30 | Fe | 31 | ◯ | P | 26 | 1.0 | 316 | 48 | 14.0 | 1.6 | Example |

*◯: When a rate of continuous pores exceeds 50%, X: The others
**P: Pearlite, C: Cementite, F: Ferrite
***Boundary strength/Boundary strength when Ni-resist cast iron subjected to aluminum plating treatment is insert-cast

Any of the examples of the present invention becomes the composite for a wear-resistant ring in which the aluminum alloy is impregnated into the pores, the radial crushing strength is more than or equal to 300 MPa, and the thermal conductivity is more than or equal to 40 W/m/K, and which has excellent heat conductivity. In the examples of the present invention, in comparison with the conventional wear-resistant ring made of Ni-resist cast iron, the heat conductivity is improved about twice or more (the thermal conductivity of the Ni-resist cast iron material is about 20 W/m/K). Each of the examples of the present invention becomes an excellent composite for a wear-resistant ring in which the linear expansion coefficient is in a range of 13.6 to 16.9×10⁻⁶/K, and the boundary strength (the bonding strength) with respect to the aluminum alloy is high and is more than or equal to 1.5 times the boundary strength (the bonding strength) with respect to the aluminum alloy the composite obtained by insert-casting the wear-resistant ring made of Ni-resist cast iron.

Meanwhile, the comparative examples deviating from the scope of the present invention become composites cannot secure desired characteristics because the radial crushing strength does not satisfy a desired value, the thermal conductivity is lower than a predetermined value, and the heat conductivity is reduced, the boundary strength is reduced when the boundary strength with respect to the aluminum alloy is less than 1.5 times the boundary strength when the wear-resistant ring made of Ni-resist cast iron is insert-cast in the aluminum alloy, or the linear expansion coefficient is less than 13.6×10⁻⁶/K.

1. A composite for a wear-resistant ring having excellent heat conductivity, which is formed by insert-casing an iron-based sintered compact for a wear-resistant ring in an aluminum alloy, wherein
the iron-based sintered compact for a wear-resistant ring is an iron-based sintered compact comprising:
a composition that comprises, by mass, C of 0.4 to 1.5% and Cu of 20 to 40% and is composed of a balance of Fe and inevitable impurities, and
a structure in which pores exist continuously at a porosity of 15 to 50% in terms of volume fraction, a matrix is pearlite, and a free Cu phase is dispersed in the matrix,
the aluminum alloy is impregnated into the pores, and
a thermal conductivity is more than or equal to 40 W/m/K and a radial crushing strength is more than or equal to 300 MPa.

2. The composite for a wear-resistant ring according to claim 1, wherein, in addition to the thermal conductivity and the radial crushing strength, a linear expansion coefficient from room temperature to 300° C. is 13.6 to 16.9×10⁻⁶/K, and a boundary strength with respect to the aluminum alloy is higher than or equal to 1.5 times a boundary strength with respect to an aluminum alloy of a composite formed by insert-casting a wear-resistant ring made of Ni-resist cast iron subjected to aluminum plating treatment in the aluminum alloy.

3. The composite for a wear-resistant ring according to claim 1, wherein the structure of the iron-based sintered compact for a wear-resistant ring is a structure in which, in addition to the free Cu phase, dispersion particles containing Mo or Si are further dispersed in the matrix at a total of 2% by mass or less.

4. The composite for a wear-resistant ring according to claim 2, wherein the structure of the iron-based sintered compact for a wear-resistant ring is a structure in which, in addition to the free Cu phase, dispersion particles containing Mo or Si are further dispersed in the matrix at a total of 2% by mass or less.
